(19) United States
(12) Patent Application Publication
(10) Pub. No.: US 2018/0050521 A1
(43) Pub. Date: Feb. 22, 2018

(54) FABRIC FOR SUPPORT

(71) Applicant: NIPPON SIGMAX CO., LTD., Shinjuku-ku (JP)

(72) Inventor: Kyohei IKARASHI, Shinjuku-ku (JP)

(73) Assignee: NIPPON SIGMAX CO., LTD., Shinjuku-ku (JP)

(21) Appl. No.: 15/561,181

(22) PCT Filed: Mar. 23, 2016
(86) PCT No.: PCT/JP2016/059208

§ 371 Date: Sep. 25, 2017

(30) Foreign Application Priority Data
Mar. 26, 2015 (JP) 2015-063712

(51) Int. Cl. B32B 27/08; B32B 33/00; B32B 37/10; B32B 37/12; B32B 37/14; B32B 7/02

(52) U.S. Cl. CPC B32B 27/08; B32B 33/00; B32B 37/10; A41D 13/06; B32B 37/144; B32B 7/02; B32B 2260/046; B32B 37/12

(57) ABSTRACT

A fabric for support including: a first synthetic resin film layer that is less stretchable than a stretchable substrate formed on a top surface of the stretchable substrate within the stretchable substrate, and a second synthetic resin film layer that is less stretchable than the first synthetic resin film layer formed on a top surface of the first synthetic resin film layer within the first synthetic resin film layer. The fabric for support has fixing strength despite being thin and prevents peeling of a synthetic resin.

### FIELD OF THE INVENTION

The present invention relates to a fabric for support, and more particularly to the fabric suitable for making a support that in itself has sufficient fixing strength despite being thin.

### BACKGROUND OF THE INVENTION

A thin support is known in which a less stretchable area is formed by partially bonding a synthetic resin to stretchable fabric (for example, see Patent Literature 1).

However, since the synthetic resin bonded area of such a conventional support is difficult to stretch compared to the other area, there was a problem that though the conventional support somewhat compresses the corresponding part of a human body at the time of wearing, fixing strength applied to an affected area, such as a joint, is insufficient. On the other hand, since the difference in the degree of stretch between the stretchable fabric and the synthetic resin more increases if a much less stretchable synthetic resin is bonded in order to increase fixing strength, there was a problem that the synthetic resin peels from the stretchable fabric.

### CITATION LIST

### Patent Literature

Patent Literature 1: JP 2005-125541 A

### SUMMARY OF THE INVENTION

### Technical Problem

The present invention, which has been made in view of the foregoing problems, is directed to a fabric for support that in itself has sufficient fixing strength despite being thin and prevents the peeling of a synthetic resin part.

### Solution to Problem

As a result of extensive research aimed at solving the above-mentioned problems, the inventor of the present invention found that a very good result can be achieved by forming on a top surface of a stretchable substrate a first synthetic resin film layer that is less stretchable than the stretchable substrate and by forming and coating on the first synthetic resin film layer a second synthetic resin film layer that is less stretchable than the first synthetic resin film layer, and thus the inventor has completed the present invention.

That is, the present invention solves the above-mentioned problem by a fabric for support, in which, at least, a first synthetic resin film layer that is less stretchable than a stretchable substrate is formed on a top surface of the stretchable substrate within the stretchable substrate, and a second synthetic resin film layer that is less stretchable than the first synthetic resin film layer is formed on a top surface of the first synthetic resin film layer within the first synthetic resin film layer.

### Effect of the Invention

The fabric for support of the present invention, in which synthetic resin film layers are sequentially laminated on the stretchable substrate, has sufficient fixing strength in itself and does not necessarily need a fixing strap or the like.

Additionally, the difference in the degree of stretch between the stretchable substrate and the first synthetic resin film layer and the difference in the degree of stretch between the first synthetic resin film layer and the second synthetic resin film layer do not increase remarkably, so that the first synthetic resin film layer and/or the second synthetic resin film layer are prevented from peeling.

### BRIEF DESCRIPTION OF DRAWINGS

FIG. 1 is a cross-sectional view of fabric for support according to the present invention.

FIG. 2 is a plan view of the fabric for support according to the present invention.

FIG. 3 is a cross-sectional view illustrating another embodiment of the fabric for support according to the present invention.

FIG. 4 is a plan view of an ankle support made by using the fabric for support according to the present invention.

FIG. 5 is a perspective view illustrating an example of wearing the ankle support of FIG. 4.

### DETAILED DESCRIPTION OF THE INVENTION

Embodiments of the present invention are described below with reference to the drawings.

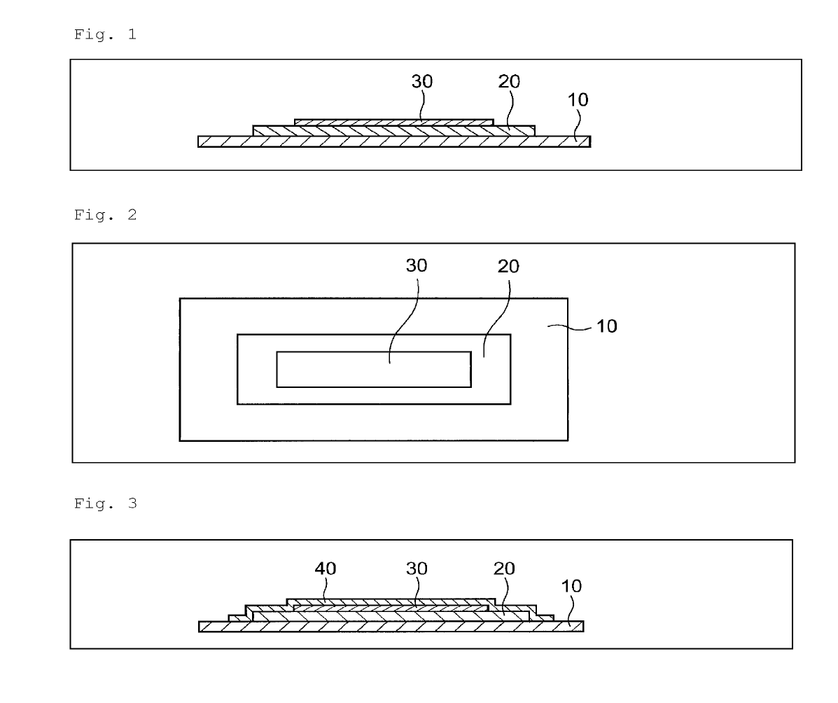

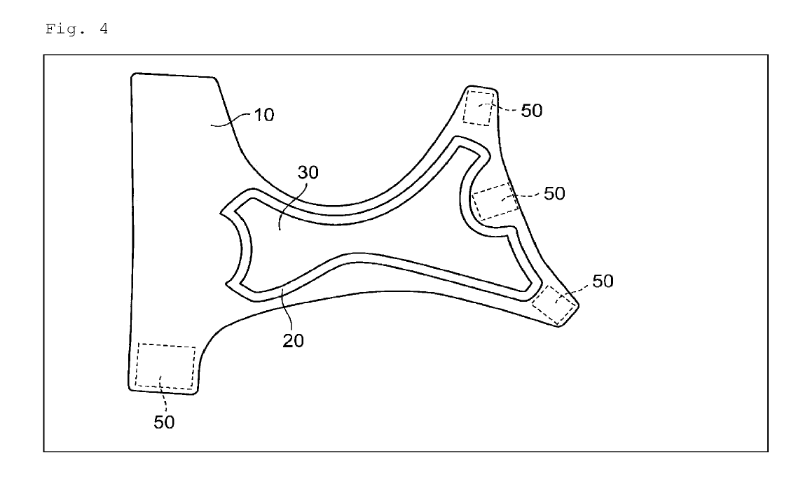

In FIGS. 1 and 2, reference numeral 10 designates a stretchable substrate, reference numeral 20 designates a first synthetic resin film layer, and reference numeral 30 designates a second synthetic resin film layer.

The stretchable substrate 10 is not particularly limited as long as it has a stretch and, for example, a commonly used thin (about 0.3 to 2 mm thick) fabric for support is preferably used.

The first synthetic resin film layer 20 is less stretchable than the stretchable substrate 10, that is, the first synthetic resin film layer 20 has a low stretch ratio, and the first synthetic resin film layer 20 is formed on a top surface of the stretchable substrate 10 within the stretchable substrate 10.

The second synthetic resin film layer 30 is less stretchable than the first synthetic resin film layer 20, that is, the second synthetic resin film layer 30 has a low stretch ratio, and the second synthetic resin film layer 30 is formed on a top surface of the first synthetic resin film layer 20 within the first synthetic resin film layer 20.

The method of forming the first synthetic resin film layer 20 and the second synthetic resin film layer 30 is not particularly limited and, for example, a method of pressing and forming the synthetic resin film layers through an adhesive applied thereto or a method of pressing and forming by applying heat at a temperature above the melting point of the synthetic resins of the synthetic resin film layers 20, 30 is preferable. In particular, pressing and forming by applying heat at a temperature above the melting point in the latter method causes part of the upper synthetic resins to be impregnated into the lower stretchable substrate 10 or to be melted and integrated with the lower first synthetic resin film layer 20, which advantageously prevents peeling of the first synthetic resin film layer 20 and/or the second synthetic resin film layer 30 in a more reliable manner.

A number of other synthetic resin film layers (not shown), if appropriate, may be laminated on a top surface of the second synthetic resin film layer 30. In this case, the above other synthetic resin film layers are less stretchable than the synthetic resin film layer thereunder and are formed within the synthetic resin film layer. This is desirable to obtain a support that has fixing strength and prevents peeling.

As described above, a number of other synthetic resin film layers 40 may be laminated on a top surface of the uppermost one of the laminated synthetic resin film layers beyond any synthetic resin film layers thereunder (i.e., the second synthetic resin film layer 30 and the first synthetic resin film layer 20 of FIG. 3) and within the stretchable substrate 10, as illustrated in FIG. 3. In this case, while the synthetic resin film layer 40 may be more stretchable than any lower synthetic resin film layers (i.e., the second synthetic resin film layer 30 and the first synthetic resin film layer 20 illustrated in FIG. 3) and the stretchable substrate 10, the synthetic resin film layer 40 may be formed of a film layer that is more stretchable than any lower synthetic resin film layers (i.e., the second synthetic resin film layer 30 and the first synthetic resin film layer 20 illustrated in FIG. 3) and is less stretchable than the stretchable substrate 10. This is desirable to obtain a support that maintains fixing strength and prevents peeling.

Materials of the synthetic resin films for the first synthetic resin film layer 20, the second synthetic resin film layer 30, and other synthetic resin film layers are not particularly limited and, for example, thermoplastic rubbery synthetic resins are preferably used, which are preferably about 0.05 to 0.5 mm thick.

Assuming a stretch ratio of the stretchable substrate 10 is 10, the following stretch ratios of the first synthetic resin film layer 20 and the second synthetic resin film layer 30 are desirable in maintaining fixing strength and preventing peeling, where the stretch ratio of two-layer part comprised of the stretchable substrate 10 and the first synthetic resin film layer 20 is 2 to 3, and the stretch ratio of three-layer part comprised of the stretchable substrate 10, the first synthetic resin film layer 20 and the second synthetic resin film layer 30 is 1 (herein a tensile tester for determining the stretch ratio is, for example, “STROGRAPH VES5D” manufactured by Toyo Seiki Co., Ltd.).

As described above, the fabric for support according to the present invention includes at least the first synthetic resin film layer 20 that is less stretchable than the stretchable substrate 10 and more stretchable than the second synthetic resin film layer 30 and that is interposed between the most stretchable substrate 10 and the least stretchable second synthetic resin film layer 30, so that the difference in the degree of stretch between the stretchable substrate 10 and the first synthetic resin film layer 20 is less than the difference in the degree of stretch when the least stretchable second synthetic resin film layer 30 is directly laminated on the top surface of the stretchable substrate 10, thus preventing the first synthetic resin film layer 20 from peeling from the stretchable substrate 10. Similarly, the difference in the degree of stretch between the first synthetic resin film layer 20 and the second synthetic resin film layer 30 is less than the difference in the degree of stretch between the stretchable substrate 10 and the second synthetic resin film layer 30, thus preventing the second synthetic resin film layer 30 from peeling from the first synthetic resin film layer 20.

Accordingly, when the outer shape of the fabric for support according to the present invention is formed in accordance with a body part on which the fabric for support is worn, and detachable hook-and-loop fastener is provided at some ends thereof, a support can be obtained that has sufficient fixing strength despite being thin and prevents the peeling of the synthetic resin film layers.

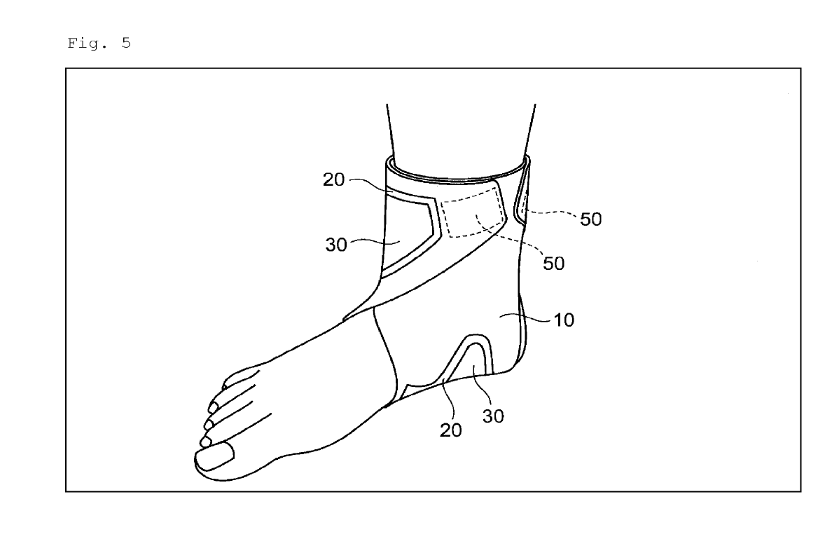

FIG. 4 illustrates an exemplary ankle support made by using the fabric for support according to the present invention. The fabric for support is configured such that peripheral of the fabric for support (i.e., stretchable substrate 10) are formed into a generally concave curved shape in order to avoid “sagging” when wound and attached on the ankle, and detachable hook-and-loop fastener 50 is provided at the end.

Wearing this ankle support on the ankle as illustrated in FIG. 5 enables an ankle to be securely held using only the support and without using a strap or the like.

### REFERENCE SIGNS LIST

10: stretchable substrate

20: first synthetic resin film layer

30: second synthetic resin film layer

40: other synthetic resin film layer(s)

50: hook fastener

1. A fabric for support, comprising
a stretchable substrate;
a first synthetic resin film layer; and
a second synthetic resin film layer,
wherein, at least, the first synthetic resin film layer that is less stretchable than the stretchable substrate is formed on a top surface of the stretchable substrate within the stretchable substrate, and the second synthetic resin film layer that is less stretchable than the first synthetic resin film layer is formed on a top surface of the first synthetic resin film layer within the first synthetic resin film layer.

2. The fabric for support according to claim 1,
wherein the first synthetic resin film layer and the second synthetic resin film layer are formed by pressing a synthetic resin film.

3. The fabric for support according to claim 2,
wherein the first synthetic resin film layer and the second synthetic resin film layer are pressed and formed through an adhesive.

4. The fabric for support according to claim 2,
wherein the first synthetic resin film layer and the second synthetic resin film layer are pressed and formed by applying heat at a temperature above melting points of synthetic resins of the first synthetic resin film layer and the second synthetic resin film layer.

5. The fabric for support according to claim 4,
wherein part of the synthetic resin of the second synthetic resin film layer is impregnated into the stretchable substrate by pressing.

6. The fabric for support according to claim 1, further comprising a number of other synthetic resin film layers,
wherein the other synthetic resin film layers are laminated on a top surface of an uppermost synthetic resin film layer of the fabric for support without any synthetic resin film layers thereunder and within the stretchable substrate.

7. The fabric for support according to claim 2, further comprising a number of other synthetic resin film layers,
wherein the other synthetic resin film layers are laminated on a top surface of an uppermost synthetic resin film layer of the fabric for support without any synthetic resin film layers thereunder and within the stretchable substrate.

8. The fabric for support according to claim 3, further comprising a number of other synthetic resin film layers,
wherein the other synthetic resin film layers are laminated on a top surface of an uppermost synthetic resin film layer of the fabric for support without any synthetic resin film layers thereunder and within the stretchable substrate.

9. The fabric for support according to claim 4, further comprising a number of other synthetic resin film layers,
wherein the other synthetic resin film layers are laminated on a top surface of an uppermost synthetic resin film layer of the fabric for support without any synthetic resin film layers thereunder and within the stretchable substrate.

10. The fabric for support according to claim 5, further comprising a number of other synthetic resin film layers,
wherein the other synthetic resin film layers are laminated on a top surface of an uppermost synthetic resin film layer of the fabric for support without any synthetic resin film layers thereunder and within the stretchable substrate.
